(19) United States
(12) Patent Application Publication
(10) Pub. No.: US 2023/0388054 A1
(43) Pub. Date: Nov. 30, 2023

(54) CONTROL INFORMATION TRANSMISSION

(71) Applicant: Telefonaktiebolaget LM Ericsson (publ), Stockholm (SE)

(72) Inventor: Min Wang, Luleå (SE)

(21) Appl. No.: 18/031,671

(22) PCT Filed: Sep. 3, 2021
(86) PCT No.: PCT/EP2021/074421

§ 371 Date: Apr. 13, 2023

(30) Foreign Application Priority Data
Oct. 22, 2020 (WO) PCT/EP2020/079760

(51) Int. Cl. H04L 1/1607; H04L 5/00

(52) U.S. Cl. CPC H04L 1/1671; H04L 5/0055

(57) ABSTRACT

The present disclosure provides methods performed by wireless devices and base stations. In a particular aspect, there is provided a method performed by a first wireless device. The first wireless device is communicating with a base station in a cellular communication network via a second wireless device. The method comprises sending control information relating to a connection between the first wireless device and the second wireless device to the base station.

### TECHNICAL FIELD

This disclosure relates to control information relating to a connection between two wireless devices.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Sidelink (SL) transmissions over New Radio (NR) are specified for Release (Rel.) 16. These are enhancements of the PROximity-based SErvices (ProSe) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver user equipment (UE) to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH (Physical Sidelink Common Control Channel, a SL version of the Physical Downlink Control Channel (PDCCH)).
To achieve a high connection density, congestion control and thus the Quality of Service (QoS) management is supported in NR sidelink transmissions.

To enable the above enhancements, new physical channels and reference signals are introduced in NR (available in Long Term Evolution (LTE) before):
Physical Sidelink Shared Channel (PSSCH), a SL version of Physical Downlink Shared Channel (PDSCH): The PSSCH is transmitted by a sidelink transmitter UE, which conveys sidelink transmission data, system information blocks (SIBs) for radio resource control (RRC) configuration, and a part of the sidelink control information (SCI).
Physical Sidelink Feedback Channel (PSFCH), a SL version of Physical Uplink Control Channel (PUCCH): The PSFCH is transmitted by a sidelink receiver UE for unicast and groupcast, which conveys 1 bit information over 1 RB for the Hybrid Automatic Repeat Request (HARQ) acknowledgement (ACK) and the negative ACK (NACK). In addition, channel state information (CSI) is carried in the medium access control (MAC) control element (CE) over the PSSCH instead of the PSFCH.
Physical Sidelink Common Control Channel (PSCCH), a SL version of Physical Downlink Control Channel (PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink (DL) transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of processes of acquiring timing and frequency synchronization together with SSIDs of UEs is called an initial cell search. Note that the UE sending the S-PSS/S-SSS may not necessarily be involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. The SSB is transmitted periodically every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for Frequency Range 2 (FR2) transmission (which includes frequency bands from 24.25 GHz to 52.6 GHz.

Another new feature is the two-stage sidelink control information (SCI). This is a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as an 8-bit source identity (ID) and a 16-bit destination ID, New Data Indicator (NDI), RV and HARQ process ID is sent on the PSSCH to be decoded by the receiver UE.

Similar to ProSe in LTE, NR sidelink transmissions have the following two modes of resource allocation:
Mode 1: Sidelink resources are scheduled by a gNB.
Mode 2: The UE autonomously selects sidelink resources from a (pre-)configured sidelink resource pool(s) based on the channel sensing mechanism.

For an in-coverage UE, a gNB can be configured to adopt Mode 1 or Mode 2. For an out-of-coverage UE, only Mode 2 can be adopted. As in LTE, scheduling over the sidelink in NR is done in different ways for Mode 1 and Mode 2. Mode 1 supports the following two kinds of grants:

Dynamic grant: When the traffic to be sent over sidelink arrives at a transmitter UE, this UE should launch the four-message exchange procedure to request sidelink resources from a gNB (Scheduling Request (SR) on uplink (UL), grant, buffer status report (BSR) on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

PSFCH reception—As captured in clause 5.22.1.3.2 in TS 38.321 v.16.2.1 [reference 2]:

The MAC entity shall for each PSSCH transmission:

1 > if an acknowledgement corresponding to the PSSCH transmission in clause 5.22.1.3.1a of TS
38.321 [2] is obtained from the physical layer:
2 > deliver the acknowledgement to the corresponding Sidelink HARQ entity for the Sidelink
process;
1 > else:
2 > deliver a negative acknowledgement to the corresponding Sidelink HARQ entity for the
Sidelink process;
1 > if the PSSCH transmission occurs for a pair of Source Layer-2 ID and Destination Layer-2 ID
corresponding to a PC5-RRC connection which has been established by upper layers:
2 > perform the HARQ-Based Sidelink RLF Detection procedure as specified in clause
5.22.1.3.3 of TS 38.321 [2].
If sl-PUCCH-Config is configured by RRC, the MAC entity shall for a PUCCH transmission occasion:
1 > if the timeAlignmentTimer, associated with the TAG containing the Serving Cell on which the HARQ
feedback is to be transmitted, is stopped or expired:
2 > not instruct the physical layer to generate acknowledgement(s) of the data in this TB.
1 > else if a MAC PDU has been obtained for a sidelink grant associated to the PUCCH transmission
occasion in clause 5.22.1.3.1 of TS 38.321 [2], the MAC entity shall:
2 > if the most recent transmission of the MAC PDU was not prioritized as specified in clause
5.22.1.3.1a of TS 38.321 [2]:
3 > instruct the physical layer to signal a negative acknowledgement on the PUCCH
according to clause 16.5 of TS 38.213 [10].
2 > else if HARQ feedback has been disabled for the MAC PDU and next retransmission(s) of
the MAC PDU is not required:
3 > instruct the physical layer to signal a positive acknowledgement corresponding to
the transmission on the PUCCH according to clause 16.5 of TS 38.213 [10].
2 > else if HARQ feedback has been disabled for the MAC PDU and no sidelink grant is
available for next retransmission(s) of the MAC PDU, if any:
3 > instruct the physical layer to signal a negative acknowledgement corresponding to
the transmission on the PUCCH according to clause 16.5 of TS 38.213 [10].
2 > else:
3 > instruct the physical layer to signal an acknowledgement corresponding to the
transmission on the PUCCH according to clause 16.5 of TS 38.213 [10]
1 > else:
2 > instruct the physical layer to signal a positive acknowledgement on the PUCCH according
to clause 16.5 of TS 38.213 [10].

Layer 2 (L2) UE-to-Network relay

In the TR 23.752 v0.3.0 clause 6.7[reference 3], the layer-2 based UE-to-Network relay is described.

The protocol architecture supporting a L2 UE-to-Network Relay UE is provided. The L2 UE-to-Network Relay UE provides forwarding functionality that can relay any type of traffic over the PC5 link. The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

FIG. 1 illustrates the protocol stack for the user plane transport, related to a PDU Session, including a Layer 2 UE-to-Network Relay UE. FIG. 1 corresponds to Figure A.2.1-1 in TR 23.752 v0.3.0[3]. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP link are the Remote UE and the gNB (the NG-RAN). The relay function is performed below PDCP. This means that data security is ensured between the Remote UE and the gNB without exposing raw data at the UE-to-Network Relay UE.

The adaptation relay layer within the UE-to-Network Relay UE can differentiate between signalling radio bearers (SRBs) and data radio bearers (DRBs) for a particular Remote UE. The adaptation relay layer is also responsible for mapping PC5 traffic to one or more DRBs of the Uu. The definition of the adaptation relay layer is under the responsibility of RAN WG2.

FIG. 2 illustrates the protocol stack of the Non-Access Stratum (NAS) connection for the Remote UE to the NAS-Mobility Management (MM) and NAS-Session Management (SM) components. FIG. 2 corresponds to Figure A.2.2-1 in TR 23.752 v0.3.0 [3]. The NAS messages are transparently transferred between the Remote UE and 5G-AN over the Layer 2 UE-to-Network Relay UE using:
a PDCP end-to-end connection where the role of the UE-to-Network Relay UE is to relay the PDUs over the signalling radio bear without any modifications;
a N2 connection between the 5G-Access Network (AN) and AMF over N2; and
a N3 connection AMF and SMF over N11.

The role of the UE-to-Network Relay UE is to relay the PDUs from the signalling radio bearer without any modifications.

FIG. 3 is an illustration of connection establishment for indirect communication via a UE-to-Network Relay UE. FIG. 3 corresponds to FIG. 6.7.3-1 in TR 23.752 v0.3.0 [3]. The numbered paragraphs below relate to the corresponding numbered steps/signals in FIG. 3.
0. If in coverage, the Remote UE and UE-to-Network Relay UE may independently perform the initial registration to the network according to registration procedures in TS 23.502 [8]. The allocated 5G GUTI of the Remote UE is maintained when later NAS signalling between Remote UE and Network is exchanged via the UE-to-Network Relay UE.

NOTE: The current procedures shown here assume a single hop relay.
1. If in coverage, the Remote UE and UE-to-Network Relay UE independently get the service authorization for indirect communication from the network.
2-3. The Remote UE and UE-to-Network Relay UE perform UE-to-Network Relay UE discovery and selection.
4. Remote UE initiates a one-to-one communication connection with the selected UE-to-Network Relay UE over PC5, by sending an indirect communication request message to the UE-to-Network Relay.
5. If the UE-to-Network Relay UE is in CM_IDLE state, triggered by the communication request received from the Remote UE, the UE-to-Network Relay UE sends a Service Request message over PC5 to its serving AMF.

The Relay's AMF may perform authentication of the UE-to-Network Relay UE based on NAS message validation and if needed the AMF will check the subscription data.

If the UE-to-Network Relay UE is already in CM_CONNECTED state and is authorised to perform Relay service then step 5 is omitted.
6. The UE-to-Network Relay UE sends the indirect communication response message to the Remote UE.
7. Remote UE sends a NAS message to the serving AMF. The NAS message is encapsulated in an RRC message that is sent over PC5 to the UE-to-Network Relay UE, and the UE-to-Network Relay UE forwards the message to the NG-RAN. The NG-RAN derives Remote UE's serving AMF and forwards the NAS message to this AMF.

NOTE: It is assumed that the Remote UE's PLMN is accessible by the UE-to-Network Relay's PLMN and that UE-to-Network Relay UE AMF supports all S-NSSAIs the Remote UE may want to connect to.

If Remote UE has not performed the initial registration to the network in step 0, the NAS message is initial registration message. Otherwise, the NAS message is service request message.

If the Remote UE performs initial registration via the UE-to-Network relay, the Remote UE's serving AMF may perform authentication of the Remote UE based on NAS message validation and if needed the Remote UE's AMF checks the subscription data.

For service request case, User Plane connection for PDU Sessions can also be activated. The other steps follow the clause 4.2.3.2 in TS 23.502 [8].
8. Remote UE may trigger the PDU Session Establishment procedure as defined in clause 4.3.2.2 of TS 23.502 [8].
9. The data is transmitted between Remote UE and UPF via UE-to-Network Relay UE and NG-RAN. The UE-to-Network Relay UE forwards all the data messages between the Remote UE and NG-RAN using RAN specified L2 relay method.

### SUMMARY

There currently exist certain challenge(s). In the 3GPP Rel-17 Study Item on NR sidelink relay (3GPP RP-193253 [reference 7]) started in RAN2, the below objectives will be studied during the 3GPP Rel-17 time frame.

This study item targets to study single-hop NR sidelink-based relay.
1. Study mechanism(s) with minimum specification impact to support the SA requirements for sidelink-based UE-to-network and UE-to-UE relay, focusing on the following aspects (if applicable) for layer-3 relay and layer-2 relay [RAN2];
   A. Relay (re)selection criterion and procedure;
   B. Relay/Remote UE authorization;
   C. QoS for relaying functionality;
   D. Service continuity;
   E. Security of relayed connection after SA3 has provided its conclusions;
   F. Impact on user plane protocol stack and control plane procedure, e.g., connection management of relayed connection;
2. Study mechanism(s) to support upper layer operations of discovery modeVprocedure for sidelink relaying, assuming no new physical layer channel /signal [RAN2];

According to the above study objectives, SL based UE-to-network (U2N) relay is in the scope of the study item. A layer-2 (L2) relay as one important scenario is being studied in 3GPP. In the case of a L2 relay, a remote UE connects to a serving gNB via a relay UE. The remote UE is visible at the gNB, meaning that there is a corresponding UE context stored at the serving gNB. According to the NR SL feature already specified in NR Rel-16, a UE is able to transmit the HARQ feedback of every PSSCH transmission on the sidelink between the UE and another destination UE to the gNB via PUCCH. Upon reception of the SL HARQ feedback from the remote UE, the gNB can be aware of the SL status. The gNB can therefore further improve SL scheduling based on received SL HARQ feedback. However, this feature cannot be directly applied to a remote UE in a L2 relay scenario, since the remote UE may have no direct connection to its serving gNB. Therefore, it is useful to improve this feature to be applicable to a remote UE in the case of a L2 relay.

Certain aspects of the present disclosure and their embodiments may provide solutions to these or other challenges.

In a first embodiment of the techniques presented herein, for a remote UE connecting to a serving gNB via a relay UE, for every PSSCH transmission from the remote UE to the relay UE, the remote UE may send the HARQ feedback corresponding to the PSSCH transmission (i.e., SL HARQ feedback) to the gNB via at least one of the below options:

Option 1: transmit the HARQ feedback of the PSSCH transmission (i.e. SL HARQ feedback) on PUCCH via a direct path to the gNB.

Option 2: transmit the HARQ feedback of the PSSCH transmission (i.e., SL HARQ feedback) on PUSCH via a direct path to the gNB.

Option 3: transmits the HARQ feedback of the PSSCH transmission (i.e., SL HARQ feedback) on PSCCH to the relay UE and the relay UE further forwards the information to the gNB on PUCCH.

Option 4: transmits the HARQ feedback of the PSSCH transmission (i.e., SL HARQ feedback) on PSCCH to the relay UE and the relay UE further forwards the information to the gNB on PUSCH.

Option 5: transmits the HARQ feedback of the PSSCH transmission (i.e., SL HARQ feedback) on PSSCH to the relay UE and the relay UE further forwards the information to the gNB on PUCCH.

Option 6: transmits the HARQ feedback of the PSSCH transmission (i.e., SL HARQ feedback) on PSSCH to the relay UE and the relay UE further forwards the information to the gNB on PUSCH.

Option 1 or Option 2 is applicable in cases where the remote UE has a direct connection to the gNB. In other words, the remote UE may have both a direct signalling path and an indirect signalling path connecting to the gNB. This may occur in the case where the remote UE moves to the cell edge, and for service continuity purposes, the remote UE may keep both paths for a short while especially during a path switch procedure. In this case, in order to improve transmission reliability, the remote UE may apply multiple options at the same time to transmit a same SL HARQ feedback to the gNB. The gNB will only process the first received feedback transmission while ignoring the other feedback transmissions.

The gNB may configure a remote UE on which of the above signalling options to apply/use.

For Option 3 and Option 4, the SL HARQ feedback for one or multiple SL HARQ processes may be carried reusing existing fields in the existing SCI format, or new fields can be added into the existing SCI format. Alternatively, a new SCI format may be introduced.

For Option 5 and Option 6, the SL HARQ feedback for one or multiple SL HARQ processes may be carried by at least one of the below alternatives:
reusing existing fields in the existing SCI format, or new fields added into the existing SCI format. Alternatively, a new SCI format may be introduced.
a MAC CE.
a RRC signalling message (e.g., PC5 RRC or Uu RRC)
a control PDU of a protocol layer (e.g., SDAP, PDCP, RLC, or adaptation layer)

For either of the options (including Option 3, 4, 5 and 6), after the relay UE has received SL HARQ feedback for one or multiple SL HARQ processes from the remote UE, the relay UE maps the information to fields in a UCI, which is further transmitted on PUCCH or PUSCH. For different remote UE, the relay UE may be configured with respective PUCCH resources for forwarding SL HARQ feedback of the remote UE. In case the UCI carrying the SL HARQ feedback of a remote UE is transmitted on PUSCH by the relay UE, the relay UE may use a dynamic grant or a configured grant. In case there is no available grant, the relay UE may trigger a SR to the gNB for requesting resources. For each remote UE, the relay UE may be configured with respective PUCCH-SR resource for requesting PUSCH resources to transmit the SL HARQ feedback of the remote UE.

In the second embodiment, for a remote UE connecting to a serving gNB via a relay UE, for every PSSCH transmission from the remote UE to the relay UE, while the relay UE sends the HARQ feedback corresponding to the received PSSCH transmission (i.e. SL HARQ feedback) to the remote UE, the relay UE may also send same SL HARQ feedback to the gNB for the remote UE. The relay UE may send the remote UE's SL HARQ feedback to the gNB via PUCCH or PUSCH. For different remote UEs, the relay UE may be configured with respective PUCCH resources for forwarding SL HARQ feedback of the remote UE. In case the UCI carrying the SL HARQ feedback of a remote UE is transmitted on PUSCH by the relay UE, the relay UE may use a dynamic grant or a configured grant. In case there is no available grant, the relay UE may trigger a SR to the gNB for requesting resources. For each remote UE, the relay UE may be configured with respective PUCCH-SR for requesting PUSCH resources to transmit the SL HARQ feedback of the remote UE.

Further embodiments are envisaged, as discussed further below.

Thus there are, proposed herein, various embodiments which address one or more of the issues disclosed herein.

According to a first aspect, there is provided a method performed by a first wireless device. The first wireless device is communicating with a base station in a cellular communication network via a second wireless device. The method comprises sending control information relating to a connection between the first wireless device and the second wireless device to the base station.

According to a second aspect, there is provided a method performed by a second wireless device. A first wireless device is communicating with a base station in a cellular communication network via the second wireless device. The method comprises receiving control information relating to a connection between the first wireless device and the second wireless device from the first wireless device; and sending the received control information to the base station.

According to a third aspect, there is provided another method performed by a second wireless device. A first wireless device is communicating with a base station in a cellular communication network via the second wireless device. The method comprises determining hybrid automatic repeat request, HARQ, feedback relating to transmission of first data from the first wireless device to the second wireless device; and sending the determined HARQ feedback to the base station.

According to a fourth aspect, there is provided a method performed by a base station in a cellular communication network. The method comprises receiving control information relating to a connection between a first wireless device and a second wireless device.

According to a fifth aspect, there is provided a computer program product comprising a computer readable medium having computer readable code embodied therein. The computer readable code is configured such that, on execution by a suitable computer or processor, the computer or processor is caused to perform the method according to the first aspect or any embodiment thereof.

According to a sixth aspect, there is provided a first wireless device configured to perform the method according to the first aspect or any embodiment thereof.

According to a seventh aspect, there is provided a second wireless device configured to perform the method according to the second or third aspects or any embodiment thereof.

According to an eighth aspect, there is provided a base station configured to perform the method according to the fourth aspect or any embodiment thereof.

According to a ninth aspect, there is provided a first wireless device comprising a processor and a memory. The memory contains instructions executable by said processor whereby said first wireless device is operative to perform the method according to the first aspect or any embodiment thereof.

According to a tenth aspect, there is provided a second wireless device comprising a processor and a memory. The memory contains instructions executable by said processor whereby said second wireless device is operative to perform the method according to the second or third aspects or any embodiment thereof.

According to an eleventh aspect, there is provided a base station comprising a processor and a memory. The memory contains instructions executable by said processor whereby said base station is operative to perform the method according to the fourth aspect or any embodiment thereof.

According to a twelfth aspect, there is provided a first wireless device configured to communicate with a base station in a cellular communication network via a second wireless device. The first wireless device comprises a sending unit configured to send control information relating to a connection between the first wireless device and the second wireless device to the base station.

According to a thirteenth aspect, there is provided a second wireless device. A first wireless device is communicating with a base station in a cellular communication network via the second wireless device. The second wireless device comprises a receiving unit configured to receive control information relating to a connection between the first wireless device and the second wireless device from the first wireless device; and a sending unit configured to send the received control information to the base station.

According to a fourteenth aspect, there is provided a second wireless device. A first wireless device is communicating with a base station in a cellular communication network via the second wireless device. The second wireless device comprises a determining unit configured to determine hybrid automatic repeat request, HARQ, feedback relating to transmission of first data from the first wireless device to the second wireless device; and a sending unit configured to send the determined HARQ feedback to the base station.

According to a fifteenth aspect, there is provided a base station for use in a cellular communication network. The base station comprises a receiving unit configured to receive control information relating to a connection between a first wireless device and a second wireless device.

According to a sixteenth aspect, there is provided a wireless device that comprises processing circuitry configured to perform any of the steps of the method according to the first, second or third aspects or any embodiment thereof; and power supply circuitry configured to supply power to the wireless device.

According to a seventeenth aspect, there is provided a base station that comprises processing circuitry configured to perform the method according to the fourth aspect or any embodiment thereof; and power supply circuitry configured to supply power to the base station.

According to an eighteenth aspect, there is provided a UE that comprises: an antenna configured to send and receive wireless signals; radio front-end circuitry connected to the antenna and to processing circuitry, and configured to condition signals communicated between the antenna and the processing circuitry; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE. The processing circuitry is configured to perform any of the steps of the method according to the first, second or third aspects, or any embodiment thereof.

According to a nineteenth aspect, there is provided a communication system including a host computer that comprises processing circuitry configured to provide user data; and a communication interface configured to forward the user data to a cellular network for transmission to a user equipment (UE). The cellular network comprises a base station having a radio interface and processing circuitry, the base station's processing circuitry configured to perform any of the steps of the method of the fourth aspect or any embodiment thereof.

According to a twentieth aspect, there is provided a method implemented in a communication system including a host computer, a base station and a UE. The method comprises, at the host computer, providing user data; and at the host computer, initiating a transmission carrying the user data to the UE via a cellular network comprising the base station, wherein the base station performs any of the steps of the method according to the fourth aspect or any embodiment thereof.

According to a twenty-first aspect, there is provided a UE configured to communicate with a base station, the UE comprising a radio interface and processing circuitry configured to perform the method according to the twentieth aspect or any embodiment thereof.

According to a twenty-second aspect, there is provided a communication system including a host computer comprising: processing circuitry configured to provide user data; and a communication interface configured to forward user data to a cellular network for transmission to a user equipment (UE). The UE comprises a radio interface and processing circuitry, the UE's components configured to perform any of the steps of the method according to the first, second or third aspects or any embodiment thereof.

According to a twenty-third aspect, there is provided a method implemented in a communication system including a host computer, a base station and a UE. The method comprises at the host computer, providing user data; and at the host computer, initiating a transmission carrying the user data to the UE via a cellular network comprising the base station, wherein the UE performs any of the steps of the method according to the first, second or third aspects or any embodiment thereof.

According to a twenty-fourth aspect, there is provided a communication system including a host computer comprising: a communication interface configured to receive user data originating from a transmission from a UE to a base station. The UE comprises a radio interface and processing circuitry, the UE's processing circuitry configured to perform any of the steps of the method according to the first, second or third aspects or any embodiment thereof.

According to a twenty-fifth aspect, there is provided a method implemented in a communication system including a host computer, a base station and a UE. The method comprises, at the host computer, receiving user data transmitted to the base station from the UE, wherein the UE performs any of the steps of the method according to the first, second or third aspects or any embodiment thereof.

According to a twenty-sixth aspect, there is provided a communication system including a host computer comprising a communication interface configured to receive user data originating from a transmission from a UE to a base station. The base station comprises a radio interface and processing circuitry, the base station's processing circuitry configured to perform any of the steps of the method according to the first aspect or any embodiment thereof.

According to a twenty-sixth aspect, there is provided a method implemented in a communication system including a host computer, a base station and a UE. The method comprises, at the host computer, receiving, from the base station, user data originating from a transmission which the base station has received from the UE, wherein the UE performs any of the steps of the method according to the first, second or third aspects or any embodiment thereof.

Certain embodiments may provide one or more of the following technical advantage(s). For example, with the proposed mechanisms, a remote UE can report SL HARQ feedback to the gNB in time in a relay scenario. As another example, with the proposed mechanisms, the gNB is aware of the status of a SL link between a remote UE and a relay UE so that the gNB can improve scheduling and radio resource management for the SL link.

### BRIEF DESCRIPTION OF THE DRAWINGS

Various embodiments are described herein with reference to the following drawings, in which:

FIG. 1 is an illustration of a user plane stack for a L2 UE-to-Network Relay UE;

FIG. 2 is an illustration of a control plane stack for a L2 UE-to-Network Relay UE;

FIG. 3 is an illustration of connection establishment for indirect communication via a UE-to-Network Relay UE;

FIG. 4 is a simplified illustration showing a remote UE, a relay UE and a base station;

FIG. 5 is an illustration of the transmission of HARQ feedback between a remote UE, relay UE and a base station according to various embodiments;

FIG. 6 is an illustration of the transmission of HARQ feedback between a remote UE, relay UE and a base station according to other various embodiments;

FIG. 7 is a flow chart illustrating a method performed by a first wireless device in accordance with various embodiments;

FIG. 8 is a flow chart illustrating a method performed by a second wireless device in accordance with various embodiments;

FIG. 9 is a flow chart illustrating a method performed by a second wireless device in accordance with other various embodiments;

FIG. 10 is a flow chart illustrating a method performed by a base station in accordance with various embodiments;

FIG. 11 is an illustration of a wireless network in accordance with some embodiments;

FIG. 12 is an illustration of a UE in accordance with some embodiments;

FIG. 13 is an illustration of a virtualisation environment in accordance with some embodiments;

FIG. 14 is an illustration of a telecommunication network connected via an intermediate network to a host computer in accordance with some embodiments;

FIG. 15 shows a host computer communicating via a base station with a user equipment over a partially wireless connection in accordance with some embodiments;

FIG. 16 shows methods implemented in a communication system including a host computer, a base station and a user equipment in accordance with some embodiments;

FIG. 17 shows methods implemented in a communication system including a host computer, a base station and a user equipment in accordance with some embodiments;

FIG. 18 shows methods implemented in a communication system including a host computer, a base station and a user equipment in accordance with some embodiments;

FIG. 19 shows methods implemented in a communication system including a host computer, a base station and a user equipment in accordance with some embodiments;

FIG. 20 is a block diagram of a wireless device in accordance with various embodiments;

FIG. 21 is a block diagram of a base station in accordance with various embodiments;

FIG. 22 is another block diagram of a first wireless device in accordance with various embodiments;

FIG. 23 is another block diagram of a second wireless device in accordance with various embodiments;

FIG. 24 is another block diagram of a second wireless device in accordance with various embodiments; and

FIG. 25 is another block diagram of a base station in accordance with various embodiments.

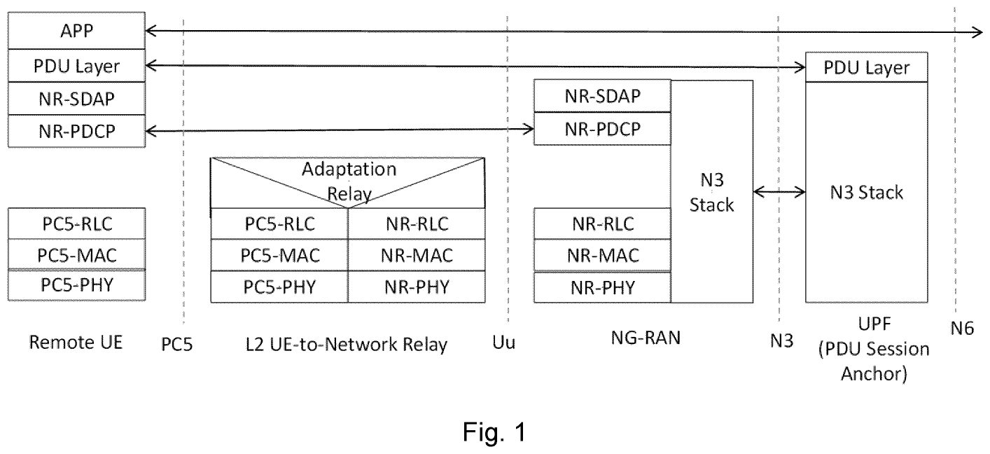

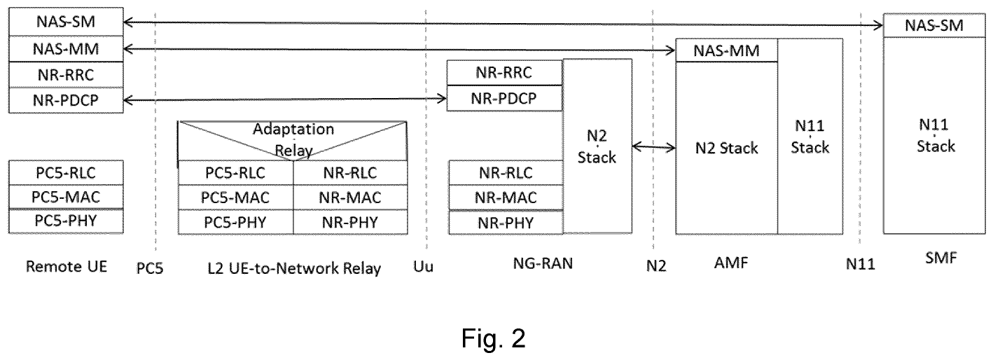

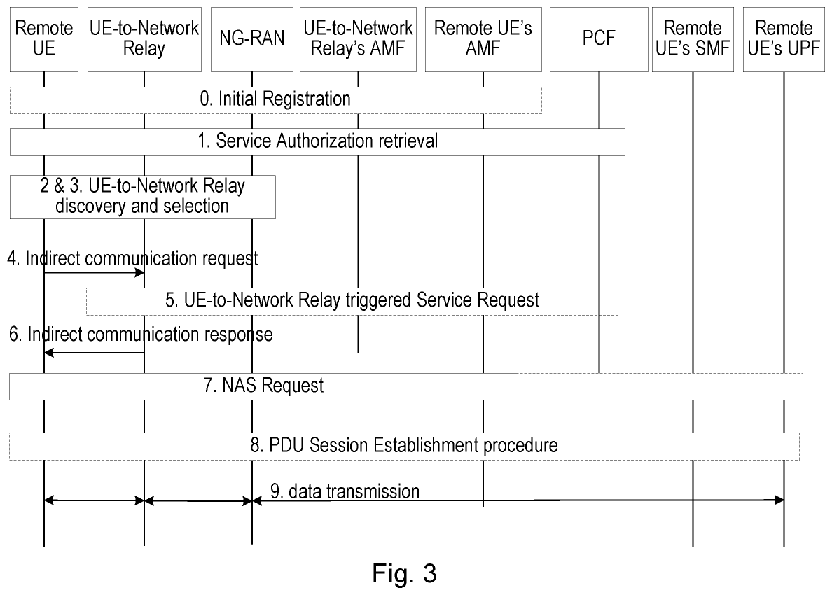

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Although the embodiments described herein are in the context of NR, i.e. a remote UE and a relay UE are deployed in a same or different NR cell, it will be appreciated that the embodiments are also applicable to other relay scenarios including a UE-to-network relay UE where the link between a remote UE and a relay UE may be based on LTE sidelink or NR sidelink, i.e. the Uu connection between a relay UE and a base station (eNB or gNb as appropriate) may be LTE Uu or NR Uu. The connection between a remote UE and a relay UE is also not limited to sidelink (e.g. NR sidelink or LTE sidelink). Any short-range communication technology such as WiFi or Bluetooth could be used instead. The disclosed embodiments can also be applied to a relay scenario where the relay UE is configured with multiple connections to the RAN (i.e. the number of connections is equal to or larger than two), e.g. using dual connectivity (DC), carrier aggregation (CA), etc.

The disclosed embodiments are applicable at least to L2 relay scenarios. Thus, a L2 UE-to-Network Relay UE (referred to herein as a “relay UE”) can provide forwarding functionality that can relay traffic over a PC5 link, and can also provide the functionality to support connectivity to the 5G System (5GS) for one or more remote UEs. A UE can be considered to be a remote UE if the UE has successfully established a PC5 link to the relay UE. A remote UE can be located within next generation radio access network (NG-RAN) coverage, or outside of NG-RAN coverage (i.e. the remote UE may or may not have coverage from the radio access network (RAN)).

The term “direct path” is used herein to represent a direct connection from a remote UE to a gNB and the term “indirect path” is used herein to represent an indirect connection between a remote UE and a gNB via an intermediate node—the relay UE.

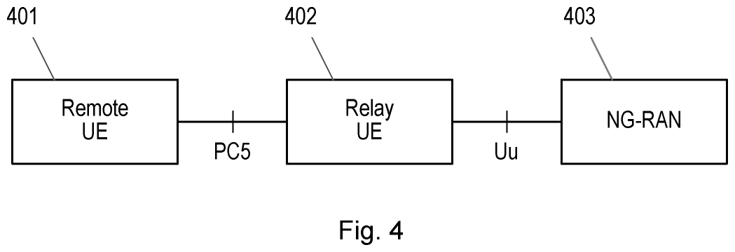

FIG. 4 illustrates an arrangement of a remote UE, a relay UE and a base station in a relay scenario. Thus, FIG. 4 shows a remote UE 401 that is connected via a relay UE 402 (e.g. a ProSe UE-to-Network Relay) to the NG-RAN 403. The NG-RAN 403 can be a NR RAN, and more specifically the NG-RAN 403 can be a base station, such as a gNB or eNB. The relay UE 402 can be a dedicated relay device, or a typical UE that can selectively operate as a relay UE 402. In the case of a 3GPP technology-based relay scenario, the interface between the remote UE 401 and the relay UE 403 can be a PC5 interface, and the interface between the relay UE 402 and the RAN 403 is the Uu interface. The relay UE entity 402 provides the functionality to support connectivity to the network 403 for remote UEs 401. It can be used for both public safety services and commercial services (e.g. an interactive service).

Embodiments of the techniques presented herein are discussed below with reference to HARQ feedback relating to the transmission of data from the remote UE 401 to the relay UE 402. Thus, the remote UE 401 has sent some data to the relay UE 402 via the D2D connection (e.g. sidelink), and the relay UE 402 provides HARQ feedback relating to the receipt (or not) of that data. The HARQ feedback can be an acknowledgement (ACK) indicating that the data has been successfully received, or a negative acknowledgement (NACK) indicating that the data has not been successfully received (e.g. the received data was corrupted or could not be decoded, or otherwise was not received at all). The techniques presented herein provide for this HARQ feedback to be communicated to the base station 403. However, although the embodiments are discussed below with reference to the communication of HARQ feedback for data transmissions from the remote UE 401, it will be appreciated that the techniques are also applicable to the communication to the base station 403 of other types of control information relating to the connection between the remote UE 401 and the relay UE 402. Such control information can include channel state information (CSI) relating to the connection.

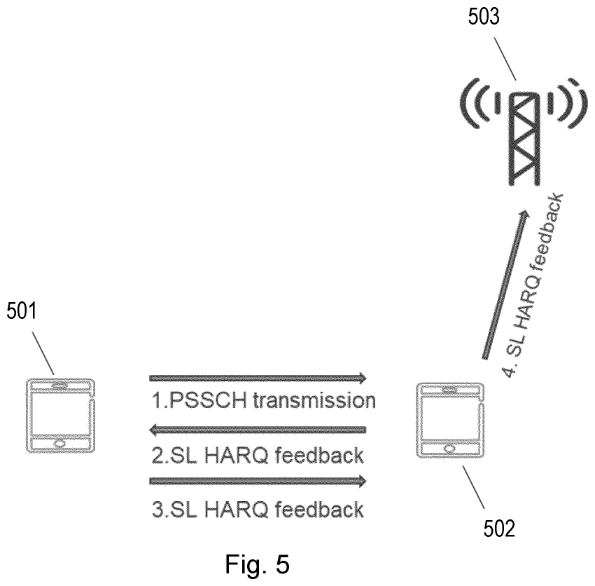

FIG. 5 illustrates the signalling of HARQ feedback according to a first set of embodiments. FIG. 5 shows a remote UE 501 that has a sidelink connection to relay UE 502. The relay UE 502 is connected to base station 503 (e.g. a gNB) and provides the remote UE 501 with access to the base station 503 (or more generally to the RAN that the base station 503 is part of and the associated core network).

The remote UE 501 transmits some data to the relay UE 502 via the sidelink connection. This data can be transmitted in a shared sidelink channel, such as the PSSCH. The data transmission is indicated by signal 1 in FIG. 5.

The relay UE 502 generates HARQ feedback relating to the transmitted data (e.g. an ACK or NACK). In this first set of embodiments, the relay UE 502 sends the HARQ feedback to the remote UE 501, as shown by signal 2 in FIG. 5. The HARQ feedback can be sent in the PSFCH.

According to the first set of embodiments, there are several options for the remote UE 501 to communicate the received HARQ feedback of the PSSCH transmission (i.e. SL HARQ feedback) to the base station (gNB) 503. For any given HARQ feedback, the remote UE 501 can use one or more of the following routes for sending the HARQ feedback to the base station 503.

The first two options require the remote UE 501 to still have a direct connection to the base station 503. In other words, the remote UE 501 may have both a direct path and an indirect path (via the relay UE 502) to the gNB 503. This may occur in cases where the remote UE 501 moves to the cell edge, and for service continuity purposes the remote UE 501 may keep both paths for a short while especially during a path switch procedure.

In the first option the remote UE 501 transmits the HARQ feedback for the (PSSCH) data transmission (i.e. SL HARQ feedback) directly to the base station 503. The HARQ feedback can be transmitted in an uplink control channel to the gNB 503, such as in PUCCH.

In the second option the remote UE 501 transmits the HARQ feedback directly to the gNB 503 in an uplink shared channel, such as PUSCH.

In the remaining four options, the remote UE 501 either does not have a direct connection to the base station 503, or does not use the direct connection to the base station 503 for sending the HARQ feedback. Thus, in the remaining four options, the remote UE 501 transmits the HARQ feedback to the relay UE 502, as shown by signal 3 in FIG. 5, and the relay UE 502 transmits the HARQ feedback to the base station 503, as shown by signal 4 in FIG. 5.

In the third option, the remote UE 501 transmits the HARQ feedback to the relay UE 502 using a control channel for the sidelink connection and the relay UE 502 forwards the HARQ feedback to the gNB 503 using an uplink control channel. The control channel for the sidelink connection can be PSCCH. The uplink control channel between the relay UE 502 and the base station 503 can be PUCCH. In this option, the HARQ feedback for one or multiple HARQ processes may be carried using existing fields in the existing sidelink control information (SCI) format, or carried using new fields added into the existing SCI format. Alternatively, a new SCI format may be introduced for the purpose of carrying the HARQ feedback.

In the fourth option, the remote UE 501 transmits the HARQ feedback to the relay UE 502 using a control channel for the sidelink connection and the relay UE 502 forwards the HARQ feedback to the gNB 503 using an uplink shared channel. The control channel for the sidelink connection can be PSCCH. The uplink shared channel between the relay UE 502 and the base station 503 can be PUSCH. As with the third option, in the fourth option the HARQ feedback for one or multiple HARQ processes may be carried using existing fields in the existing sidelink control information (SCI) format, or carried using new fields added into the existing SCI format. Alternatively, a new SCI format may be introduced for the purpose of carrying the HARQ feedback.

In the fifth option, the remote UE 501 transmits the HARQ feedback to the relay UE 502 using a shared channel for the sidelink connection and the relay UE 502 forwards the HARQ feedback to the gNB 503 using an uplink control channel. The shared channel for the sidelink connection can be PSSCH. The uplink control channel between the relay UE 502 and the base station 503 can be PUCCH.

In the sixth option, the remote UE 501 transmits the HARQ feedback to the relay UE 502 using a shared channel for the sidelink connection and the relay UE 502 forwards the HARQ feedback to the gNB 503 using an uplink shared channel. The control channel for the sidelink connection can be PSSCH. The uplink shared channel between the relay UE 502 and the base station 503 can be PUSCH.

In some embodiments, the sending of HARQ feedback to the base station 503 can be performed for every data transmission from the remote UE 501 to the relay UE 502.

As noted above, the remote UE 501 may send the HARQ feedback to the base station 503 using more than one of the above options. For example, while the remote UE 501 still has a direct connection to the base station 503, the remote UE 501 can send the HARQ feedback using one of the first two options, and also using one of the other four options. This approach can improve the reliability of the transmission of the HARQ feedback to the base station 503. In case the base station 503 receives multiple instances of the HARQ feedback relating to a particular data transmission, the base station 503 will only process the first received transmission of the HARQ feedback while ignoring the other transmissions.

For the fifth and sixth options, the HARQ feedback for one or multiple SL HARQ processes may be carried in a number of different ways. The HARQ feedback can be carried using existing fields in the existing SCI format, or using new fields added into the existing SCI format. Alternatively, a new SCI format may be introduced for the purpose of carrying the HARQ feedback. Another alternative is to include the HARQ feedback in a MAC control element (CE). Yet another alternative is to include the HARQ feedback in a RRC signalling message (e.g. a PC5 RRC message or Uu RRC message). A further alternative is to include the HARQ feedback in a control protocol data unit (PDU) of a protocol layer (e.g. Service Data Adaptation Protocol (SDAP), Packet Data Convergence Protocol (PDCP), Radio Link Control (RLC), or an adaptation layer).

The base station 503 may configure the remote UE 501 to use one or more of the above signalling options. For example the base station 503 can send an indication to the remote UE 501 (e.g. via a control channel) indicating which one or ones of the above options are to be used to send HARQ feedback to the base station 503.

For any of the options where the relay UE 502 receives the HARQ feedback back from the remote UE 501 (i.e. any of the third to sixth options) for one or multiple SL HARQ processes from the remote UE 501, the relay UE 502 can map the information to fields in uplink control information (UCI), and transmit this UCI on PUCCH or PUSCH.

If the relay UE 502 acts for several different remote UEs 501, the relay UE 502 can be configured with respective uplink control channel (e.g. PUCCH) resources for forwarding respective SL HARQ feedback for the remote UEs 501. In options where the UCI carrying the SL HARQ feedback of a remote UE 501 is transmitted on an uplink shared channel (e.g. PUSCH) by the relay UE 502, the relay UE 502 may use a dynamic grant or a configured grant. If there is no available grant, the relay UE 502 may trigger a SR to the base station 503 to request resources. If the relay UE 502 acts for several different remote UEs 501, the relay UE 502 may be configured with respective PUCCH-SR resources for requesting PUSCH resources to transmit the SL HARQ feedback of the remote UE 501.

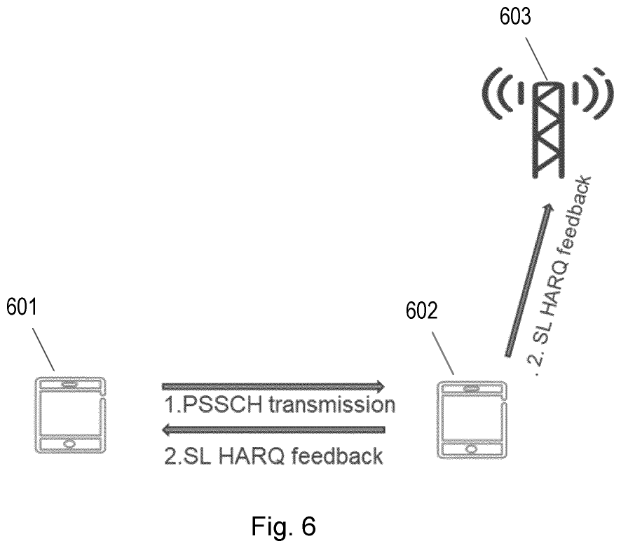

FIG. 6 illustrates the signalling of HARQ feedback according to a second set of embodiments. FIG. 6 shows a remote UE 601 that has a sidelink connection to relay UE 602. The relay UE 602 is connected to base station 603 (e.g. a gNB) and provides the remote UE 601 with access to the base station 603 (or more generally to the RAN that the base station 603 is part of and the associated core network).

The remote UE 601 transmits some data to the relay UE 602 via the sidelink connection. This data can be transmitted in a shared sidelink channel, such as the PSSCH. The data transmission is indicated by signal 1 in FIG. 6.

The relay UE 602 generates HARQ feedback relating to the transmitted data (e.g. an ACK or NACK). As in the first set of embodiments, the relay UE 602 sends the HARQ feedback to the remote UE 601, as shown by signal 2 in FIG. 6. The HARQ feedback can be sent in the PSFCH.

In contrast to the first set of embodiments where the remote UE 501 sends the HARQ feedback directly to the base station 503, or where the remote UE 501 sends the HARQ feedback back to the relay UE 502 for the relay UE 502 to forward to the base station 503, in the second set of embodiments the relay UE 602 sends the generated HARQ feedback to the base station 603 on behalf of the remote UE 601. This is shown by signal 2 in FIG. 6 from the relay UE 602 to the base station 603. The relay UE 602 can send the HARQ feedback to the base station 603 before, after, or at the same time as, the HARQ feedback is sent to the remote UE 601.

Thus, in the second set of embodiments, for a remote UE 601 connecting to a serving base station 603 via a relay UE 602, for a, or every, data transmission (e.g. on PSSCH) from the remote UE 601 to the relay UE 602, the relay UE 602 sends the HARQ feedback corresponding to the received (PSSCH) transmission (i.e. SL HARQ feedback) to the remote UE 601, the relay UE 603 also sends the same SL HARQ feedback to the base station 603 for the remote UE 601. The relay UE 602 may send the remote UE's SL HARQ feedback to the base station 603 via an uplink control channel such as PUCCH, or via an uplink shared channel, such as PUSCH. For different remote UEs 601, the relay UE 602 may be configured with respective uplink control channel (e.g. PUCCH) resources for forwarding SL HARQ feedback for particular remote UEs 601. In cases where the UCI carrying the SL HARQ feedback for a remote UE 601 is transmitted on an uplink shared channel (e.g. PUSCH) by the relay UE 602, the relay UE 602 may use a dynamic grant or a configured grant. In the event that there is no available grant, the relay UE 602 may trigger a SR to the base station 603 to request resources. For each remote UE 601, the relay UE 602 may be configured with respective PUCCH-SR resources for requesting PUSCH resources to transmit the SL HARQ feedback of the remote UE 601.

In a third set of embodiments, for a remote UE connecting to a serving base station via a relay UE, for a, or every, data transmission from the remote UE to the relay UE (e.g. on PSSCH), the remote UE may send HARQ feedback corresponding to the data transmission (e.g. SL HARQ feedback) to the base station without receiving explicit HARQ feedback from the relay UE. In other words, the remote UE can itself determine the HARQ feedback for one or multiple SL HARQ processes after performing data transmissions (e.g. via PSSCH) to the relay UE. The determination of the HARQ feedback can be made immediately after the transmission of the data, or after a configured time period following the data transmission. Once the HARQ feedback is determined by the remote UE, the remote UE can send this HARQ feedback to the base station using any of the options set out above in the first set of embodiments.

The determination of the HARQ feedback can take into account any of the following conditions or configurations:
The radio channel quality of the connection between the remote UE and the relay UE at the time of data transmission. The radio channel quality can be indicated by any of RSRP, RSRQ, RSSI, SINR, SIR, CQI, channel occupancy etc. An ACK can be assumed if the radio channel quality is above a threshold. A NACK can be assumed if the radio channel quality is below the same, or another, threshold.
The relay UE is applying a NACK-only HARQ feedback mode. In this case, the remote UE determines an ACK if the remote UE doesn't receive any HARQ feedback during a configured time period after data transmission.
The relay UE signals to the remote UE a new grant indicating a new transmission for the same HARQ process. This can be interpreted by the remote UE as an ACK for the data transmission.
The relay UE signals to the remote UE a new grant indicating a retransmission for the same HARQ process. This can be interpreted by the remote UE as a NACK for the data transmission.
The remote UE is configured with a timer for the HARQ process. The timer is started after the data transmission of the HARQ process. When the timer expires, if the remote UE doesn't receive any HARQ feedback or any grant indicating a new transmission or a retransmission associated with the HARQ process, the remote UE can interpret it as ACK for the data transmission.

A fourth set of embodiments provides a variation to the above second set of embodiments. In the second set of embodiments, the relay UE 602 generates HARQ feedback relating to the transmitted data and sends the HARQ feedback to the remote UE 601 and to the base station 603, as shown by the two signal 2s in FIG. 6. However, in the fourth set of embodiments, for a, or every, data transmission from the remote UE to the relay UE, while the relay UE sends the HARQ feedback corresponding to the received data transmission to the base station for the remote UE, the relay UE does not send the same HARQ feedback to the remote UE.

A fifth set of embodiments relate to actions or operations of the remote UE, relay UE and/or base station in the event that a HARQ process is configured with a maximum number of retransmissions for a transport block (TB)/particular data, and the remote UE has reached the maximum number of retransmissions for the TB/data. The fifth set of embodiments can be applied to, and extend, any of the first set of embodiments or the third set of embodiments.

Thus, for a remote UE that is connected to a serving base station via a relay UE, and for a data transmission from the remote UE to the relay UE using a HARQ process that has reached the maximum number of retransmissions for the data/TB, the remote UE can signal to the base station that the maximum number of retransmissions has been reached. An indication that a maximum number of retransmission has been reached can be sent according to any of the alternatives set out below:
in RRC signalling (e.g., UU RRC);
in a MAC CE;
in L1 signalling (e.g., RACH, PUCCH); or
in a control PDU of a protocol layer such as SDAP, PDCP, RLC, or an adaptation layer.

The indication that the maximum number of retransmissions has been reached can be sent by the remote UE to the base station via a direct path, or an indirect path via the relay UE. In the latter case, the remote UE can first send the indication to the relay UE via at least one of the below signalling alternatives:
in RRC signalling (e.g., PC5-RRC);
in a MAC CE;
in L1 signalling (e.g., SCI); or
in a control PDU of a protocol layer such as SDAP, PDCP, RLC, or an adaptation layer.

The relay UE can then forward an indication that the maximum number of retransmissions has been reached to the base station via at least one of the below signalling alternatives:
in RRC signalling (e.g., UU RRC);
in a MAC CE;
in L1 signalling (e.g., RACH, PUCCH);
in a control PDU of a protocol layer such as SDAP, PDCP, RLC, or an adaptation layer.

The indication that the maximum number of retransmissions has been reached can include one or more types of information in one or more information fields. The types of information can include any of:
the reason for the reporting message (e.g. that a maximum number of retransmissions has been reached);
related HARQ process indices;
traffic types or services which are related;
flows and/or radio bearers which are related; and
MCS and TBS information related to the HARQ processes.

After reception of the indication, the base station may apply one or more of the actions set out below for the relevant remote UE in response to the maximum number of retransmissions having been reached. The possible actions can include:
reconfiguring the configured grants if those affected HARQ processes/TBs used configured grants;
sending signalling to reconfigure or reset those HARQ processes;
sending new dynamic grants for those HARQ processes for further retransmissions if necessary;
sending signalling to the remote UE to trigger bearer remapping (e.g. to remap the flows to other DRBs);
sending signalling to trigger reselection of the relay UE (i.e. the remote UE should select another UE as the relay UE);
increasing a scheduling priority of the remote UE for the related traffic types or services on the sidelink link;
increasing a scheduling priority of the remote UE for the related traffic types or services on the Uu link; and
assigning more resources to the sidelink and/or the UU link for the remote UE (e.g. more resources to transmit the data for the affected DRBs, flows).

In any of the above sets of embodiments, a capability bit can be defined that is to be used by a remote UE to indicate whether or not the remote UE supports the sending of HARQ feedback relating to data transmissions to the relay UE to the base station via the relay UE. Likewise, in any of the above sets of embodiments, a capability bit can be defined that is to be used by a relay UE to indicate whether or not the relay UE supports the sending of HARQ feedback for data transmissions from the remote UE to the base station for the remote UE.

As noted above, although the described embodiments relate to the sending of HARQ feedback to the base station, the embodiments can also or alternatively be used by a remote UE (and/or a relay UE) to send other control information relating to the connection (e.g. sidelink) between the remote UE and the relay UE to the base station. For example, the above-described embodiments can be used to send other control information such as channel state information (CSI) to the base station.

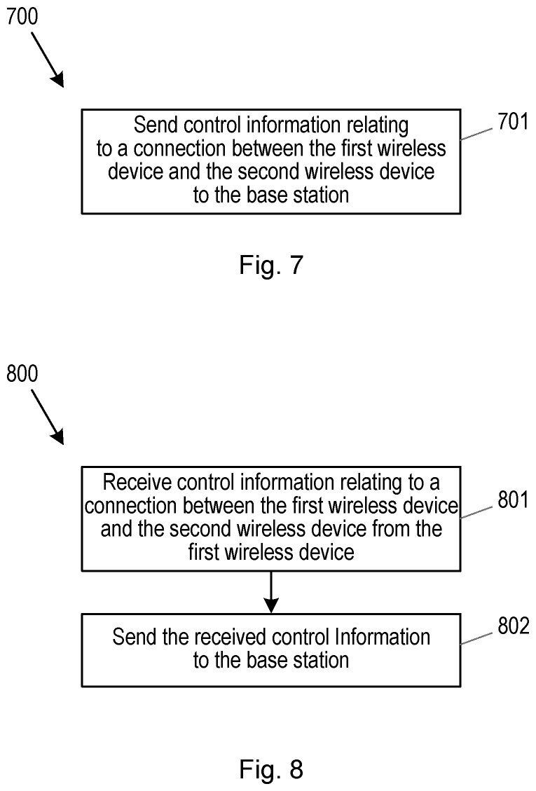

The flow chart in FIG. 7 illustrates a method 700 performed by a first wireless device in accordance with various embodiments. The first wireless device is communicating with a base station (e.g. an eNB or a gNB) in a cellular communication network via a second wireless device. The first wireless device is operating as a remote UE as described above and the second wireless device is operating as a relay UE as described above.

In step 701 the first wireless device sends control information relating to the connection between the first wireless device and the second wireless device to the base station. The control information can be channel state information relating to the connection, and/or HARQ feedback relating to data transmitted by the first wireless device to the second wireless device.

The control information can be sent to the base station via one or more of an uplink control channel established directly with the base station (e.g. PUCCH), an uplink shared channel established directly with the base station (e.g. PUSCH), a control channel established with the second wireless device (e.g. PSCCH), and a shared channel established with the second wireless device (e.g. PSSCH).

In some embodiments, the control information is sent via the control channel established with the second wireless device in a shared control information field.

In some embodiments, the control information is sent via the shared channel established with the second wireless device in any of: a shared control information field, a MAC CE, a RRC signalling message, and a control PDU.

In some embodiments, the method 700 further comprises the first wireless device receiving a first indication from the base station. The first indication provides a configuration for the first wireless device to use to send the control information to the base station.

In some embodiments, the method 700 further comprises the first wireless device sending a second indication to the base station and/or the second wireless device. The second indication, which can be a capability bit, can indicate whether the first wireless device supports the signalling of control information to the base station via the second wireless device.

In the following embodiments, the control information is HARQ feedback relating to transmission of first data from the first wireless device to the second wireless device. The HARQ feedback can comprise an ACK indicating that the first data has been successfully received by the second wireless device, or a NACK indicating that the first data has not been successfully received by the second wireless device. In these embodiments, step 701 can be performed for any data transmitted from the first wireless device to the second wireless device.

The first data may be transmitted on a shared channel established with the second wireless device, e.g. a PSSCH.

These embodiments can further comprise transmitting the first data to the second wireless device, and receiving the HARQ feedback relating to the transmission of the first data from the second wireless device. The HARQ feedback sent to the base station can correspond to the HARQ feedback received from the second wireless device.

In some embodiments, the method 700 further comprises transmitting the first data to the second wireless device; and determining the HARQ feedback for the transmission of the first data. The HARQ feedback for the transmission of the first data may be based on one or more of a quality of a transmission channel between the first wireless device and the second wireless device when the first data is transmitted, whether a negative acknowledgement, NACK, is received from the second wireless device, whether the second wireless device grants transmission of new data or a retransmission of the first data, and whether HARQ feedback and/or a grant for transmission of new data or a retransmission of the first data is received from the second wireless device within a predetermined time period of the transmission of the first data.

In some embodiments, when the first wireless device has transmitted the first data a predetermined number of times, the HARQ feedback sent to the base station can indicate a maximum number of retransmissions of the first data has been performed. HARQ feedback indicating a maximum number of retransmissions of the first data has been performed can be sent to the base station in one of: a MAC CE, a RRC signalling message, a L1 channel, and a control PDU.

The flow chart in FIG. 8 illustrates a method 800 performed by a second wireless device in accordance with various embodiments. A first wireless device is communicating with a base station (e.g. an eNB or a gNB) in a cellular communication network via the second wireless device. The first wireless device is operating as a remote UE as described above and the second wireless device is operating as a relay UE as described above.

In step 801 the second wireless device receives control information relating to the connection between the first wireless device and the second wireless device. The control information is received from the first wireless device. The control information can be channel state information relating to the connection, and/or HARQ feedback relating to data transmitted by the first wireless device to the second wireless device.

In step 802 the second wireless device sends the received control information to the base station.

The control information can be received from the first wireless device in step 801 via one or more of a control channel established with the first wireless device (e.g. PSCCH), and a shared channel established with the first wireless device (e.g. PSSCH).

In some embodiments, the control information is received via the control channel established with the second wireless device in a shared control information field. In some embodiments, the control information is received via the shared channel established with the second wireless device in any of: a shared control information field, a MAC CE, a RRC signalling message, and a control PDU.

The control information can be sent to the base station in step 802 via one or more of an uplink control channel established directly with the base station (e.g. PUCCH), and an uplink shared channel established directly with the base station (e.g. PUSCH).

In some embodiments, the second wireless device maps the received control information to one or more fields in UCI to be transmitted to the base station.

In some embodiments, the method 800 further comprises sending a third indication to the base station and/or the first wireless device. The third indication, which can be a capability bit, can indicate whether the second wireless device supports the signalling of control information for the first wireless device to the base station via the second wireless device.

In the following embodiments, the control information is HARQ feedback relating to transmission of first data from the first wireless device to the second wireless device. The HARQ feedback can comprise an ACK indicating that the first data has been successfully received by the second wireless device, or a NACK indicating that the first data has not been successfully received by the second wireless device.

In some embodiments, the HARQ feedback received in step 801 is HARQ feedback previously sent to the first wireless device by the second wireless device.

The first data can be received on a shared channel established with the first wireless device, e.g. a PSSCH.

In some embodiments, prior to step 801 the method 800 further comprises receiving the first data from the first wireless device and sending HARQ feedback relating to the receipt of the first data to the first wireless device.

In some embodiments, the method 800 further comprises the second wireless device sending the HARQ feedback relating to the receipt of the first data from the first wireless device to the base station separately from sending the received HARQ feedback to the base station in step 802.

In some embodiments, when the first wireless device has transmitted the first data a predetermined number of times, the HARQ feedback received in step 801 and/or the HARQ feedback sent to the base station in step 802 can indicate a maximum number of retransmissions of the first data has been performed. HARQ feedback indicating a maximum number of retransmissions of the first data has been performed can be received from the first wireless device and/or sent to the base station in one of: a MAC CE, a RRC signalling message, a L1 channel, and a control PDU.

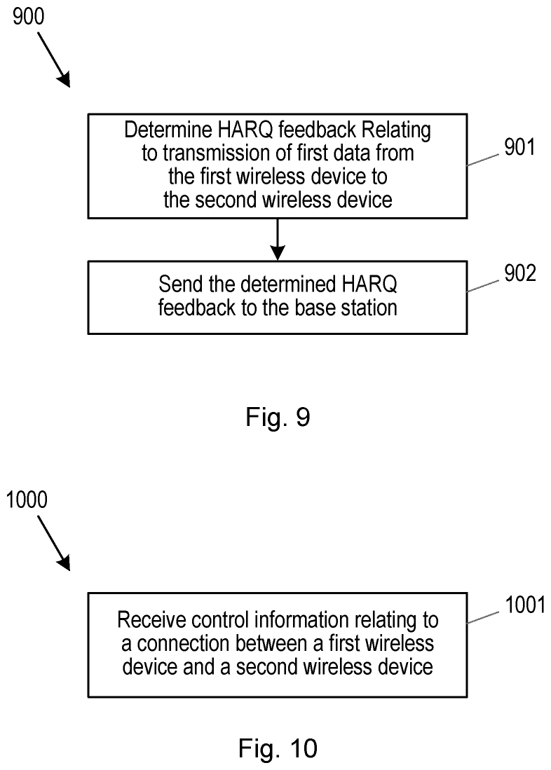

The flow chart in FIG. 9 illustrates a method 900 performed by a second wireless device in accordance with other various embodiments. A first wireless device is communicating with a base station (e.g. an eNB or a gNB) in a cellular communication network via the second wireless device. The first wireless device is operating as a remote UE as described above and the second wireless device is operating as a relay UE as described above.

In step 901 the second wireless device determines HARQ feedback relating to transmission of first data from the first wireless device to the second wireless device. The HARQ feedback can be an ACK or NACK.

In step 902 the second wireless device sends the determined HARQ feedback to the base station.

In some embodiments, the first data can be received on a shared channel established with the first wireless device, e.g. a PSSCH.

The HARQ feedback can be sent to the base station in step 902 via one or more of an uplink control channel established directly with the base station (e.g. PUCCH), and an uplink shared channel established directly with the base station (e.g. PUSCH).

In some embodiments, the method 900 further comprises sending a third indication to the base station and/or the first wireless device. The third indication, which can be a capability bit, can indicate whether the second wireless device supports the signalling of HARQ feedback for data transmissions from the first wireless device to the base station.

In some embodiments, the second wireless device does not send the determined HARQ feedback to the first wireless device. In other embodiments, the second wireless device does send the determined HARQ feedback to the first wireless device.

The flow chart in FIG. 10 illustrates a method 1000 performed by a base station (e.g. an eNB or gNB) in a cellular communication network in accordance with various embodiments. In step 1001 the base station receives control information relating to a connection between a first wireless device and a second wireless device. The first wireless device is communicating with the base station via the second wireless device. The first wireless device is operating as a remote UE as described above and the second wireless device is operating as a relay UE as described above. The control information can be channel state information relating to the connection, and/or HARQ feedback relating to data transmitted by the first wireless device to the second wireless device.

The control information can be received in step 1001 from the first wireless device via one or more of an uplink control channel established directly with the first wireless device (e.g. PUCCH); and an uplink shared channel established directly with the first wireless device (e.g. PUSCH).

In some embodiments, the control information can be received in step 1001 from the second wireless device. The control information can be received from the second wireless device via one or more of an uplink control channel established directly with the second wireless device (e.g. PUCCH); and an uplink shared channel established directly with the second wireless device (e.g. PUSCH).

In some embodiments, the method 1000 further comprises the base station receiving a first indication relating to the first wireless device. The first indication, which can be a capability bit, indicates whether the first wireless device supports the signalling of control information to the base station via the second wireless device.

In some embodiments, the method 1000 further comprises the base station receiving a second indication relating to the second wireless device. The second indication, which can be a capability bit, indicates whether the second wireless device supports the signalling of control information for the first wireless device to the base station.

In some embodiments, the method 1000 further comprises the base station sending a third indication to the first wireless device. The third indication provides a configuration for the first wireless device to use to send the control information to the base station.

In the following embodiments, the control information is HARQ feedback relating to transmission of first data from the first wireless device to the second wireless device. The HARQ feedback can comprise an ACK indicating that the first data has been successfully received by the second wireless device, or a NACK indicating that the first data has not been successfully received by the second wireless device. In these embodiments, step 1001 can be performed for any data transmitted from the first wireless device to the second wireless device.

In some embodiments, when the first wireless device has transmitted the first data a predetermined number of times, the HARQ feedback received by the base station in step 1001 can indicate a maximum number of retransmissions of the first data has been performed. HARQ feedback indicating a maximum number of retransmissions of the first data has been performed can be sent to the base station in one of: a MAC CE, a RRC signalling message, a L1 channel, and a control PDU.

In some embodiments, the base station can perform an action in response to the received indication that a maximum number of retransmissions of the first data has been performed. The action can comprise any of reconfiguring configured grants associated with the transmission of the first data; sending signalling to the first wireless device to reconfigure or reset a HARQ process associated with the transmission of the first data; sending dynamic grants for further retransmissions of the first data; sending signalling to the first wireless device to trigger bearer remapping; sending signalling to the first wireless device to trigger reselection of a relay wireless device to use to communicate with the base station; increasing scheduling priority for the first wireless device for a traffic type or service type associated with the first data on a connection between the first wireless device and the second wireless device; increasing scheduling priority for the first wireless device for a traffic type or service type associated with the first data on a connection between the first wireless device and the base station; and assigning further resources to a connection between the first wireless device and the second wireless device and/or a connection between the first wireless device and the base station.

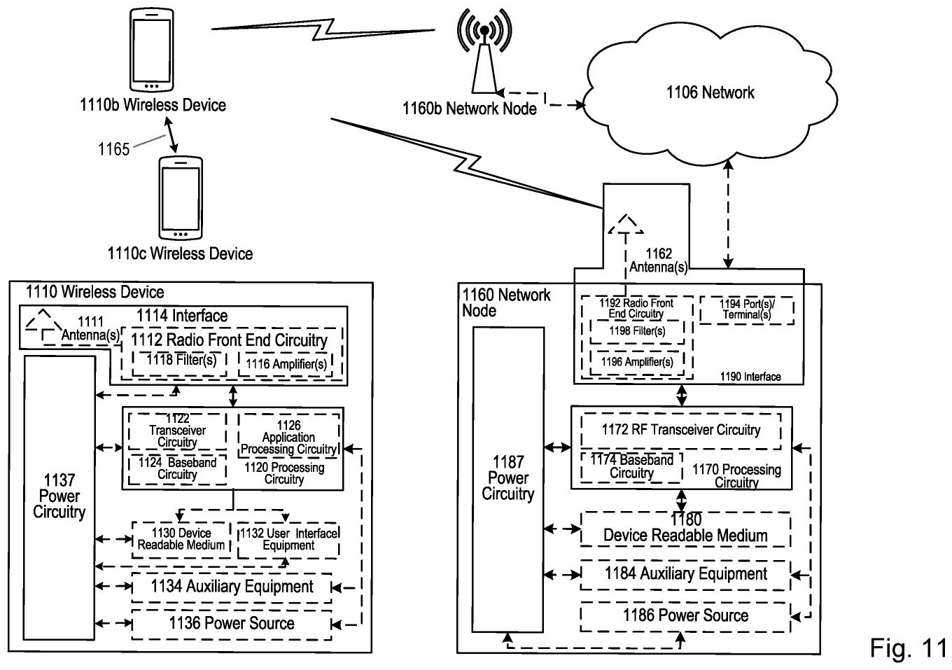

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units.

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals 1164, 1165. In FIG. 11, WD 1110b can be considered as operating as a relay UE for WD 1110c, which is operating as a remote UE and may not otherwise have a connection (or perhaps coverage) from the network nodes 1160. Antenna 1162 may be coupled to radio front end circuitry 1192 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 11 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Any of the WDs can operate as a relay UE as described herein, or as a remote UE as described herein. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. . A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as a machine type communication (MTC) device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1112 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

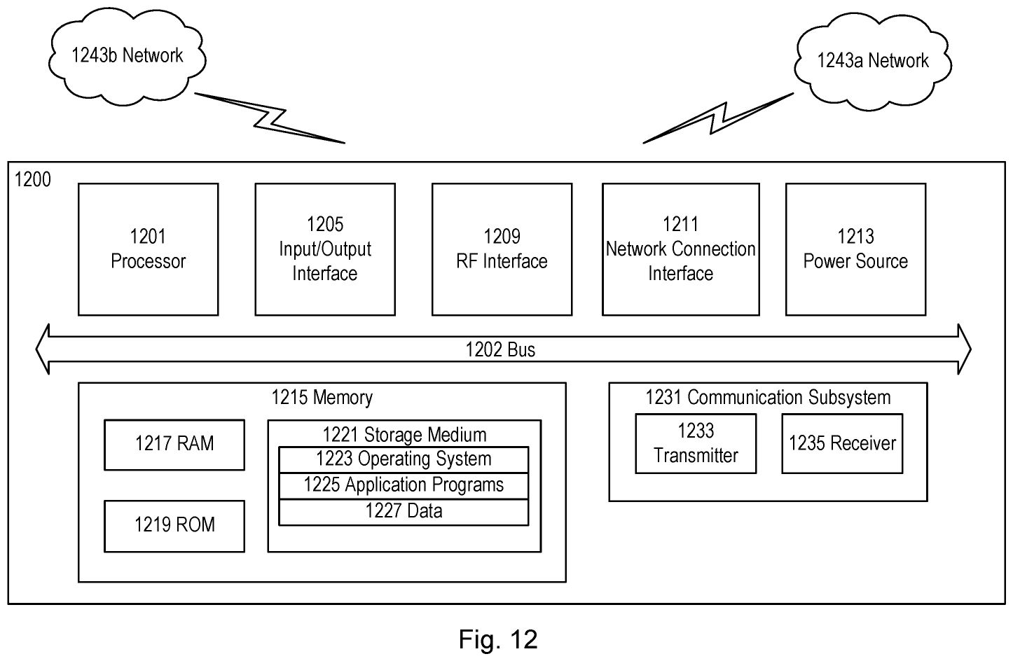

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa. The UE in FIG. 12 can operate as a relay UE or as a remote UE as described herein.

In FIG. 12, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 12, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

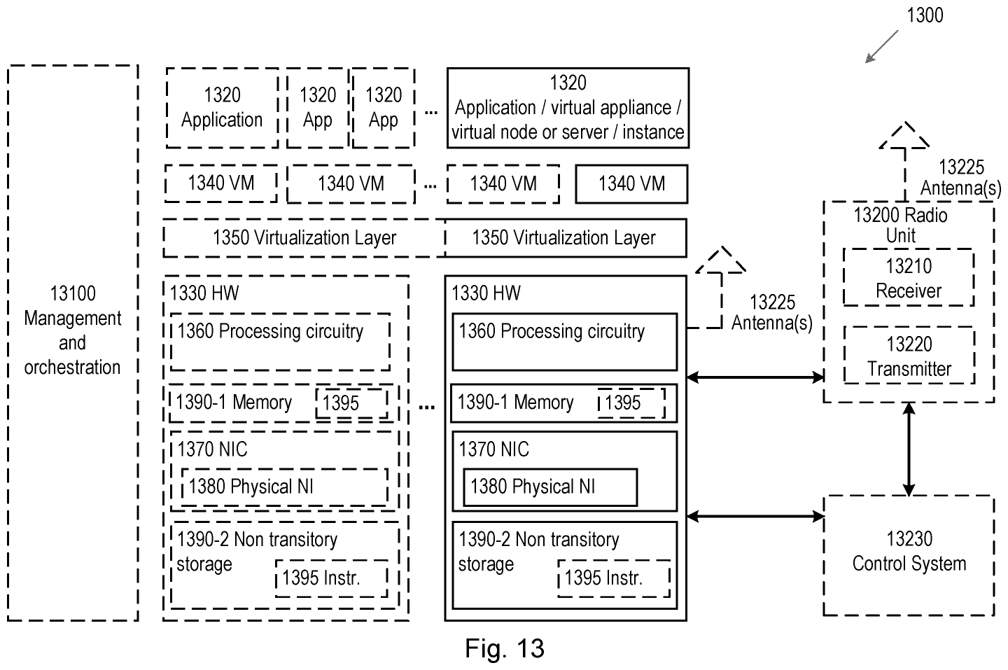

FIG. 13 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 13, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

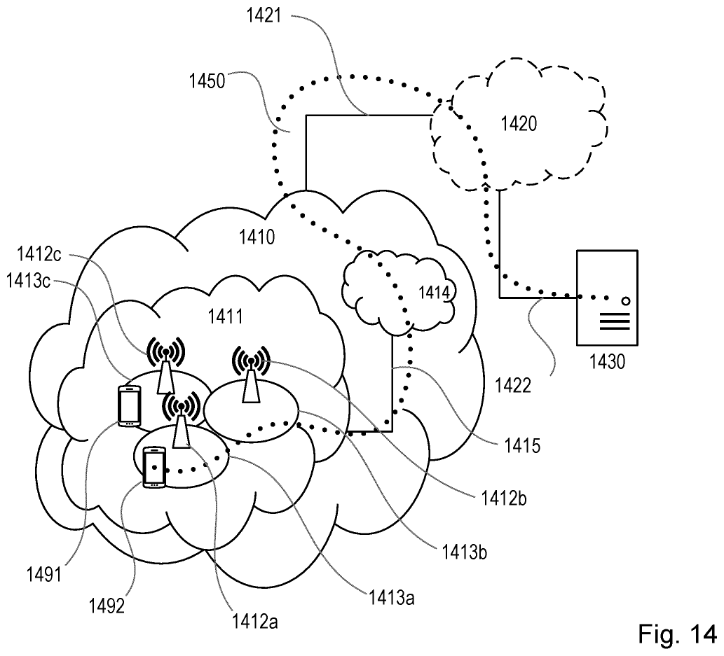

With reference to FIG. 14, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 14 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signalling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

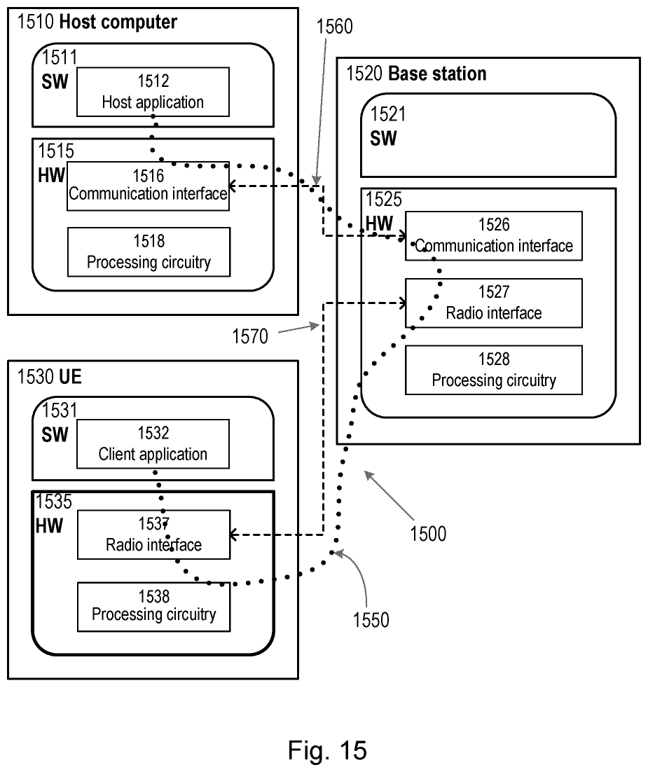

Example implementations, in accordance with an embodiment, of the UE, base station and host computer discussed in the preceding paragraphs will now be described with reference to FIG. 15. In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 15) served by base station 1520. Communication interface 1526 may be configured to facilitate connection 1560 to host computer 1510. Connection 1560 may be direct or it may pass through a core network (not shown in FIG. 15) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 15 may be similar or identical to host computer QQ430, one of base stations QQ412a, QQ412b, QQ412c and one of UEs QQ491, QQ492 of FIG. QQ4, respectively. This is to say, the inner workings of these entities may be as shown in FIG. 15 and independently, the surrounding network topology may be that of FIG. QQ4.

In FIG. 15, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the scheduling and/or radio resource management on a sidelink or other D2D link and thereby provide benefits such as a more reliable OTT service.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signalling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

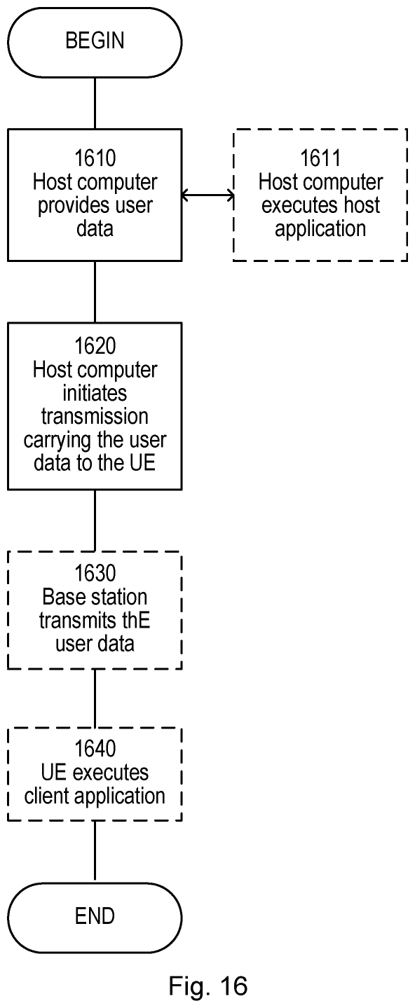

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

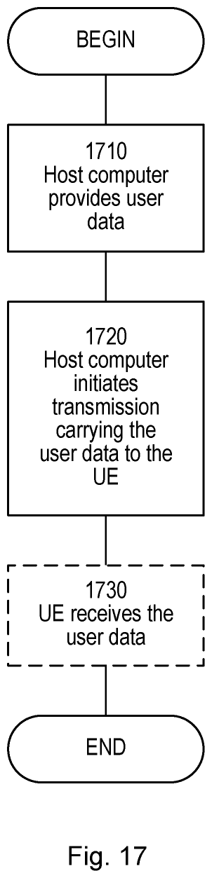

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

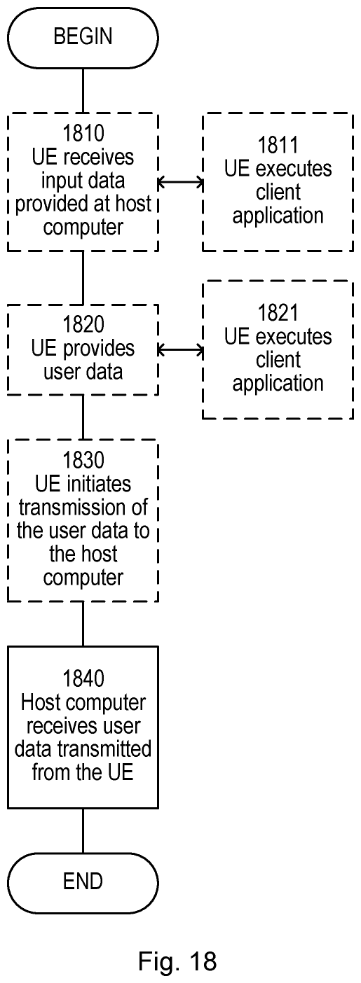

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

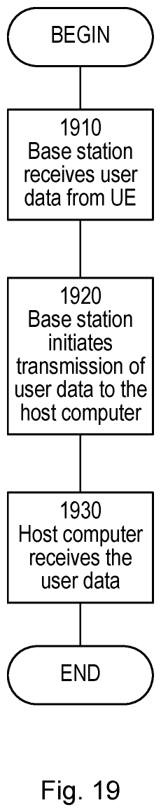

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

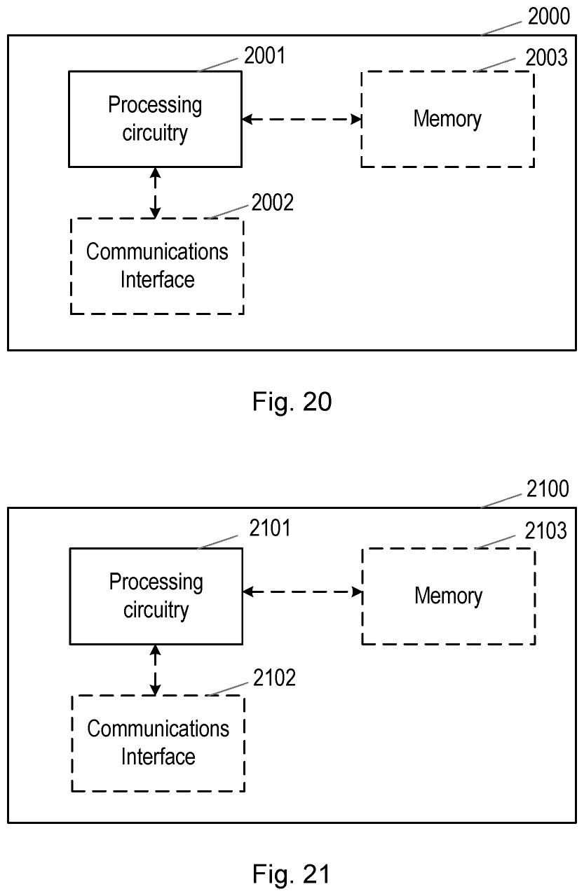

FIG. 20 is a block diagram of a wireless device (UE) in accordance with various embodiments. The wireless device 2000 in FIG. 10 can perform the methods described herein relating to the remote UE and/or the relay UE. For example the wireless device 2000 can be used to implement one or more, or all, of the steps of the methods shown in FIGS. 7-9.

The wireless device 2000 comprises processing circuitry (or logic) 2001. It will be appreciated that the wireless device 2000 may comprise one or more virtual machines running different software and/or processes.

The processing circuitry 1001 controls the operation of the wireless device 2000 and can implement the methods described herein. The processing circuitry 2001 can comprise one or more processors, processing units, multi-core processors or modules that are configured or programmed to control the wireless device 2000 in the manner described herein. In particular implementations, the processing circuitry 2001 can comprise a plurality of software and/or hardware modules that are each configured to perform, or are for performing, individual or multiple steps of the method described herein.

In some embodiments, the wireless device 2000 may optionally comprise a communications interface 2002. The communications interface 2002 can be for use in communicating with other wireless devices 2000, or base stations in a radio access network. The processing circuitry 2001 may be configured to control the communications interface 2002 to transmit to and/or receive information, data, signals, or similar.

Optionally, the wireless device 2000 may comprise a memory 2003. In some embodiments, the memory 2003 can be configured to store program code that can be executed by the processing circuitry 2001 to perform any of the methods described herein. Alternatively or in addition, the memory 2003 can be configured to store any information, data, signals, or similar that are described herein. The processing circuitry 2001 may be configured to control the memory 2003 to store such information therein.

FIG. 21 is a block diagram of a base station in accordance with various embodiments. The base station 2100 in FIG. 21 can perform the methods described herein relating to the base station, eNB or gNB. For example the base station 2100 can be used to implement one or more, or all, of the steps of the methods shown in FIG. 10. The base station 2100 comprises processing circuitry (or logic) 2101. It will be appreciated that the base station 2100 may comprise one or more virtual machines running different software and/or processes. The base station 2100 may therefore comprise one or more servers and/or storage devices and/or may comprise cloud computing infrastructure that runs the software and/or processes.

The processing circuitry 2101 controls the operation of the base station 2100 and can implement the methods described herein. The processing circuitry 2101 can comprise one or more processors, processing units, multi-core processors or modules that are configured or programmed to control the base station 2100 in the manner described herein. In particular implementations, the processing circuitry 2101 can comprise a plurality of software and/or hardware modules that are each configured to perform, or are for performing, individual or multiple steps of the method described herein.

In some embodiments, the base station 2100 may optionally comprise a communications interface 2102. The communications interface 2102 can be for use in communicating with other base stations, core network nodes, and wireless devices. The processing circuitry 2101 may be configured to control the communications interface 2102 to transmit to and/or receive information, data, signals, or similar.

Optionally, the base station 2100 may comprise a memory 2103. In some embodiments, the memory 2103 can be configured to store program code that can be executed by the processing circuitry 2101 to perform any of the methods described herein. Alternatively or in addition, the memory 2103 can be configured to store any information, data, signals, or similar that are described herein. The processing circuitry 2101 may be configured to control the memory 2103 to store such information therein.

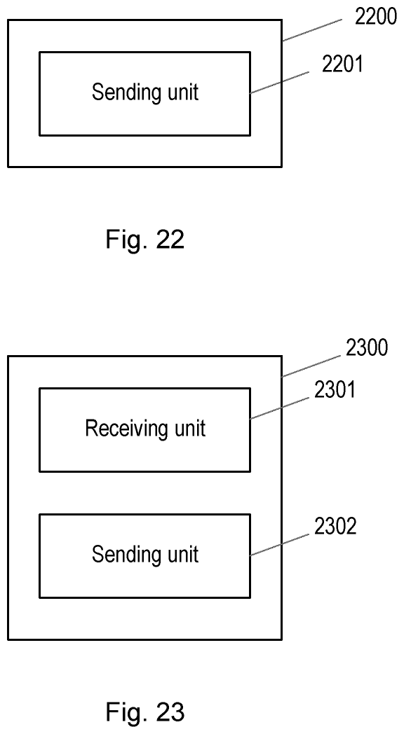

FIG. 22 illustrates a schematic block diagram of an apparatus 2200 for use in a wireless network (for example, the wireless network shown in FIG. 11). The apparatus may be implemented in a wireless device (e.g. wireless device 1110c (the remote UE) shown in FIG. 11). Apparatus 2200 is operable to carry out the example method described with reference to FIG. 7 and possibly any other processes or methods disclosed herein. It is also to be understood that the method of FIG. 7 is not necessarily carried out solely by apparatus 2200. At least some operations of the method can be performed by one or more other entities.

Virtual Apparatus 2200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause sending unit 2201 and any other suitable units of apparatus 2200 to perform corresponding functions according one or more embodiments of the present disclosure.

As illustrated in FIG. 22, apparatus 2200 includes sending unit 2201. Sending unit 2201 is configured to send control information relating to a connection between a first wireless device (in which the apparatus 2200 is implemented) and a second wireless device to a base station.

FIG. 23 illustrates a schematic block diagram of an apparatus 2300 for use in a wireless network (for example, the wireless network shown in FIG. 11). The apparatus may be implemented in a wireless device (e.g. wireless device 1110c (the relay UE) shown in FIG. 11). Apparatus 2300 is operable to carry out the example method described with reference to FIG. 8 and possibly any other processes or methods disclosed herein. It is also to be understood that the method of FIG. 8 is not necessarily carried out solely by apparatus 2300. At least some operations of the method can be performed by one or more other entities.

Virtual Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2301 and sending unit 2302 and any other suitable units of apparatus 2300 to perform corresponding functions according one or more embodiments of the present disclosure.

As illustrated in FIG. 23, apparatus 2300 includes a receiving unit 2301 and a sending unit 2302. The receiving unit 2301 is configured to receive, from a first wireless device, control information relating to a connection between the first wireless device and a second wireless device (in which the apparatus 2300 is implemented), and the sending unit 2302 is configured to send the received control information to the base station.

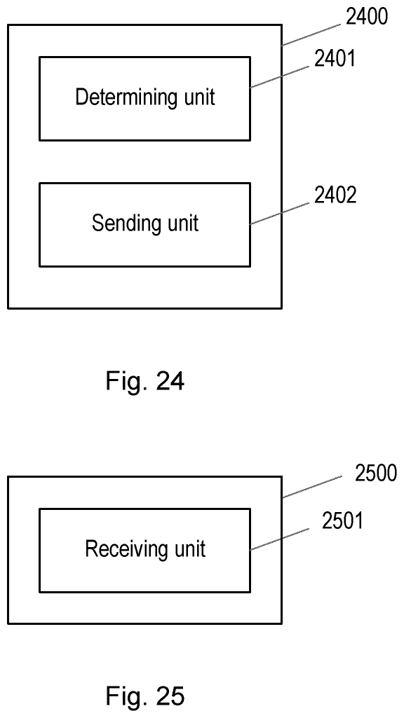

FIG. 24 illustrates a schematic block diagram of an apparatus 2400 for use in a wireless network (for example, the wireless network shown in FIG. 11). The apparatus may be implemented in a wireless device (e.g. wireless device 1110c (the relay UE) shown in FIG. 11). Apparatus 2400 is operable to carry out the example method described with reference to FIG. 9 and possibly any other processes or methods disclosed herein. It is also to be understood that the method of FIG. 9 is not necessarily carried out solely by apparatus 2400. At least some operations of the method can be performed by one or more other entities.

Virtual Apparatus 2400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining unit 2401 and sending unit 2402 and any other suitable units of apparatus 2400 to perform corresponding functions according one or more embodiments of the present disclosure.

As illustrated in FIG. 24, apparatus 2400 includes a determining unit 2401 and a sending unit 2402. The determining unit 2401 is configured to determine HARQ feedback relating to transmission of first data from a first wireless device to a second wireless device (in which the apparatus 2400 is implemented), and the sending unit 2402 is configured to send the determined HARQ feedback to a base station.

FIG. 25 illustrates a schematic block diagram of an apparatus 2500 for use in a wireless network (for example, the wireless network shown in FIG. 11). The apparatus may be implemented in a base station (e.g. network node 1160 shown in FIG. 11). Apparatus 2500 is operable to carry out the example method described with reference to FIG. 10 and possibly any other processes or methods disclosed herein. It is also to be understood that the method of FIG. 10 is not necessarily carried out solely by apparatus 2500. At least some operations of the method can be performed by one or more other entities.

Virtual Apparatus 2500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2501 and any other suitable units of apparatus 2500 to perform corresponding functions according one or more embodiments of the present disclosure.

As illustrated in FIG. 25, apparatus 2500 includes a receiving unit 2501. The receiving unit 2501 is configured to receive control information relating to a connection between a first wireless device and a second wireless device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Abbreviations

At least some of the following abbreviations may be used in this disclosure. If there is an inconsistency between abbreviations, preference should be given to how it is used above. If listed multiple times below, the first listing should be preferred over any subsequent listing(s).

| | | | |
|---|---|---|---|
| 1x RTT | CDMA2000 1x Radio Transmission | FDD | Frequency Division Duplex |
| | Technology | FFS | For Further Study |
| 3GPP | 3rd Generation Partnership Project | GERAN | GSM EDGE Radio Access Network |
| 5G | 5th Generation | gNB | Base station in NR |
| ABS | Almost Blank Subframe | GNSS | Global Navigation Satellite System |
| ACK | Acknowledgement | GSM | Global System for Mobile |
| AMF 702 | Access and Mobility Management | | communication |
| | Function | HARQ | Hybrid Automatic Repeat Request |
| ARQ | Automatic Repeat Request | HO | Handover |
| AWGN | Additive White Gaussian Noise | HSPA | High Speed Packet Access |
| BCCH | Broadcast Control Channel | HRPD | High Rate Packet Data |
| BCH | Broadcast Channel | IE | Information Element |
| BWP | Bandwidth Part | LOS | Line of Sight |
| CA | Carrier Aggregation | LPP | LTE Positioning Protocol |
| CC | Carrier Component | LTE | Long-Term Evolution |
| CCCH SDU | Common Control Channel SDU | MAC | Medium Access Control |
| CDMA | Code Division Multiplexing Access | MBMS | Multimedia Broadcast Multicast |
| CE | Control Element | | Services |
| CGI | Cell Global Identifier | MBSFN | Multimedia Broadcast multicast |
| CIR | Channel Impulse Response | MBSFN ABS | service Single Frequency Network |
| CP | Cyclic Prefix | | MBSFN Almost Blank Subframe |
| CPICH | Common Pilot Channel | MCS | Modulation and Coding Scheme |
| CPICH Ec/No | CPICH Received energy per chip | MDT | Minimization of Drive Tests |
| | divided by the power density in the | MIB | Master Information Block |
| | band | MME | Mobility Management Entity |
| CQI | Channel Quality information | MSC | Mobile Switching Center |
| C-RNTI | Cell RNTI | NACK | Negative Acknowledgement |
| CSI | Channel State Information | NDI | New Data Indicator |
| CSI-RS | CSI-Reference Signal | NPDCCH | Narrowband Physical Downlink |
| DCCH | Dedicated Control Channel | | Control Channel |
| DCI | Downlink Control Information | NR | New Radio |
| DFN | Direct Frame Number | OCNG | OFDMA Channel Noise Generator |
| DL | Downlink | OFDM | Orthogonal Frequency Division |
| DM | Demodulation | | Multiplexing |
| DMRS | Demodulation Reference Signal | OFDMA | Orthogonal Frequency Division |
| DRX | Discontinuous Reception | | Multiple Access |
| DTX | Discontinuous Transmission | OSS | Operations Support System |
| DTCH | Dedicated Traffic Channel | OTDOA | Observed Time Difference of Arrival |
| DUT | Device Under Test | O&M | Operation and Maintenance |
| E-CID | Enhanced Cell-ID (positioning | PBCH | Physical Broadcast Channel |
| | method) | P-CCPCH | Primary Common Control Physical |
| E-SMLC | Evolved-Serving Mobile Location | | Channel |
| | Centre | PCell | Primary Cell |
| ECG | Evolved CGI | PCFICH | Physical Control Format Indicator |
| eNB | E-UTRAN NodeB | | Channel |
| ePDCCH | enhanced Physical Downlink | PDCCH | Physical Downlink Control Channel |
| | Control Channel | PDCP | Packet Data Convergence Protocol |
| E-SMLC | evolved Serving Mobile Location | PDP | Profile Delay Profile |
| | Center | PDSCH | Physical Downlink Shared Channel |
| E-UTRA | Evolved UTRA | PDU | Protocol Data Unit |
| E-UTRAN | Evolved UTRAN | PGW | Packet Gateway |
| PHICH | Physical Hybrid-ARQ Indicator | RV | Redundancy Version |
| | Channel | SCH | Synchronization Channel |
| PLMN | Public Land Mobile Network | SCell | Secondary Cell |
| PMI | Precoder Matrix Indicator | SCI | Sidelink Control Information |
| PRACH | Physical Random Access Channel | SCS | Sub-Carrier Spacing |
| ProSe | Proximity-based Services | SDU | Service Data Unit |
| PRS | Positioning Reference Signal | SFN | System Frame Number |
| PSBCH | Physical Sidelink Broadcast | SGW | Serving Gateway |
| | Channel | SI | System Information |
| PSCCH | Physical Sidelink Common Control | SIB | System Information Block |
| | Channel | SL | Sidelink |
| PSFCH | Physical Sidelink Feedback | SMF | Session Management Function |
| | Channel | SNR | Signal to Noise Ratio |
| PSS | Primary Synchronization Signal | SON | Self Optimized Network |
| PSSCH | Physical Sidelink Shared Channel | S-PSS | Sidelink Primary Synchronization |
| PT-RS | Phase Tracking Reference Signal | | Signal |
| PUCCH | Physical Uplink Control Channel | SS | Synchronization Signal |
| PUSCH | Physical Uplink Shared Channel | SSB | Synchronization Signal Block |
| RACH | Random Access Channel | SSID | Sidelink Synchronization Identity |
| QAM | Quadrature Amplitude Modulation | SSS | Secondary Synchronization Signal |
| QOS | Quality of Service | S-SSS | Sidelink Secondary |
| RAN | Radio Access Network | | Synchronization Signal |
| RAT | Radio Access Technology | TDD | Time Division Duplex |
| RB | Resource Block | TDOA | Time Difference of Arrival |
| RLC | Radio Link Control | TOA | Time of Arrival |
| RLF | Radio Link Failure | TSS | Tertiary Synchronization Signal |
| RLM | Radio Link Management/Monitoring | TTI | Transmission Time Interval |
| RNC | Radio Network Controller | UCI | Uplink Control Information |
| RNTI | Radio Network Temporary Identifier | UE | User Equipment |
| RRC | Radio Resource Control | UL | Uplink |
| RRM | Radio Resource Management | UMTS | Universal Mobile |
| RS | Reference Signal | | Telecommunication System |
| RSCP | Received Signal Code Power | UPF | User Plane Function |
| RSRP | Reference Symbol Received Power | USIM | Universal Subscriber Identity |
| | OR | | Module |
| | Reference Signal Received Power | UTDOA | Uplink Time Difference of Arrival |
| RSRQ | Reference Signal Received Quality | UTRA | Universal Terrestrial Radio Access |
| | OR | UTRAN | Universal Terrestrial Radio Access |
| | Reference Symbol Received | | Network |
| | Quality | WCDMA | Wide CDMA |
| RSSI | Received Signal Strength Indicator | WLAN | Wide Local Area Network |
| RSTD | Reference Signal Time Difference | | |

References

1. 3GPP TS 23.501, V16.5.0

2. 3GPP TS 38.321 v16.2.1

3. 3GPP TR 23.752 V0.3.0

4. 3GPP TS 23.501 V16.5.0: “System Architecture for the 5G System; Stage 2”.

5. 3GPP TS 23.287 V16.3.0: “Architecture enhancements for 5G System (5GS) to support Vehicle-to-Everything (V2X) services”.

6. 3GPP TS 23.303 V16.0.0: “Proximity-based services (ProSe); Stage 2”.

7. RP-193253 “New SID: Study on NR sidelink relay”

8. 3GPP TS 23.502 V16.5.0, “Procedures for the 5G System (5GS); Stage 2”.

9. 3GPP TS 38.314 V16.0.0, “NR, Layer 2 measurements”

10. 3GPP TS 38.213 v 16.3.0.

1. A method performed by a first wireless device, wherein the first wireless device is communicating with a base station in a cellular communication network via a second wireless device, the method comprising:
sending control information relating to a connection between the first wireless device and the second wireless device to the base station.

2. The method of claim 1, wherein the control information is sent to the base station via one or more of:
an uplink control channel established directly with the base station;
an uplink shared channel established directly with the base station;
a control channel established with the second wireless device; and
a shared channel established with the second wireless device.

3-6. (canceled)

7. The method of claim 1, wherein the method further comprises:
receiving a first indication from the base station, wherein the first indication provides a configuration for the first wireless device to use to send the control information to the base station.

8. The method of claim 1, wherein the method further comprises:
sending a second indication to the base station and/or the second wireless device, the second indication indicating whether the first wireless device supports the signalling of control information to the base station via the second wireless device.

9. The method of claim 1, wherein the control information is hybrid automatic repeat request, HARQ, feedback relating to transmission of first data from the first wireless device to the second wireless device.

10-12. (canceled)

13. The method of claim 9, wherein the method further comprises:
transmitting the first data to the second wireless device; and
receiving the HARQ feedback relating to the transmission of the first data from the second wireless device.

14. The method of claim 9, wherein the method further comprises:
transmitting the first data to the second wireless device; and
determining the HARQ feedback for the transmission of the first data.

15. The method of claim 14, wherein the step of determining the HARQ feedback for the transmission of the first data is based on one or more of:
a quality of a transmission channel between the first wireless device and the second wireless device when the first data is transmitted;
whether a negative acknowledgement, NACK, is received from the second wireless device;
whether the second wireless device grants transmission of new data or a retransmission of the first data; and
whether HARQ feedback and/or a grant for transmission of new data or a retransmission of the first data is received from the second wireless device within a predetermined time period of the transmission of the first data.

16. The method of claim 9, wherein the HARQ feedback comprises an acknowledgement, ACK, indicating that the first data has been successfully received by the second wireless device, or a negative acknowledgement, NACK, indicating that the first data has not been successfully received by the second wireless device.

17. (canceled)

18. The method of claim 9, wherein, when the first wireless device has transmitted the first data a predetermined number of times, the HARQ feedback sent to the base station indicates a maximum number of retransmissions of the first data has been performed.

19. (canceled)

20. (canceled)

21. A method performed by a second wireless device, wherein a first wireless device is communicating with a base station in a cellular communication network via the second wireless device, the method comprising:
receiving control information relating to a connection between the first wireless device and the second wireless device from the first wireless device; and
sending the received control information to the base station.

22-28. (canceled)

29. The method of claim 21, wherein the method further comprises:
sending a third indication to the base station and/or the first wireless device, the third indication indicating whether the second wireless device supports the signalling of control information for the first wireless device to the base station via the second wireless device.

30-33. (canceled)

34. The method of claim 30, wherein the method further comprises, prior to receiving the HARQ feedback from the first wireless device:
receiving the first data from the first wireless device; and
sending HARQ feedback relating to the receipt of the first data to the first wireless device.

35. The method of claim 34, wherein the method further comprises:
sending the HARQ feedback relating to the receipt of the first data from the first wireless device to the base station separately from sending the received HARQ feedback to the base station.

36. (canceled)

37. (canceled)

38. A method performed by a second wireless device, wherein a first wireless device is communicating with a base station in a cellular communication network via the second wireless device, the method comprising:
determining hybrid automatic repeat request, HARQ, feedback relating to transmission of first data from the first wireless device to the second wireless device; and
sending the determined HARQ feedback to the base station.

39-42. (canceled)

43. The method of claim 38, wherein the method further comprises:
sending a third indication to the base station and/or the first wireless device, the third indication indicating whether the second wireless device supports the signalling of HARQ feedback for data transmissions from the first wireless device to the base station.

44. (canceled)

45. A method performed by a base station in a cellular communication network, the method comprising:
receiving control information relating to a connection between a first wireless device and a second wireless device.

46-50. (canceled)

51. The method of claim 45, wherein the method further comprises:
receiving a first indication relating to the first wireless device, wherein the first indication indicates whether the first wireless device supports the signalling of control information to the base station via the second wireless device.

52. The method of claim 45, wherein the method further comprises:
receiving a second indication relating to the second wireless device, wherein the second indication indicates whether the second wireless device supports the signalling of control information for the first wireless device to the base station.

53. The method of claim 45, wherein the method further comprises:
sending a third indication to the first wireless device, wherein the third indication provides a configuration for the first wireless device to use to send the control information to the base station.

54-104. (canceled)
